(19) United States
(12) Patent Application Publication
(10) Pub. No.: US 2012/0205584 A1
(43) Pub. Date: Aug. 16, 2012

(54) METHOD FOR PRODUCING A MAGNESIUM-ALPHA-SIALON-HOSTED PHOSPHOR

(75) Inventors: Shyan-Lung Chung, Tainan (TW); Feng-Sheng Chang, Tainan (TW); Huan-Yu Chen, Tainan (TW); Shu-Chi Huang, Tainan (TW)

(73) Assignee: NATIONAL CHENG KUNG UNIVERSITY, Tainan (TW)

(21) Appl. No.: 13/251,825

(22) Filed: Oct. 3, 2011

(30) Foreign Application Priority Data
Feb. 16, 2011 (TW) 100105059

(51) Int. Cl. C09K 11/79

(52) U.S. Cl. 252/301.4 F

(57) ABSTRACT

A method for producing a phosphor includes: providing a blend composed of: (i) a magnesium source; (ii) a silicon source; (iii) an aluminum source; (iv) an oxygen source; (v) a solid nitrogen source; (vi) an ammonium halide; and (vii) an activator ion source; coating the blend with an initiator to obtain a tablet; placing the tablet in a heat insulator; placing a ceramic powder between the tablet and the heat insulator; and heating the tablet to obtain a magnesium-alpha-SiAlON-hosted phosphor.

### CROSS-REFERENCE TO RELATED APPLICATION

This non-provisional application claims priority under 35 U.S.C. §119(a) on Patent Application No. 100105059 filed in Taiwan R.O.C. on Feb. 16, 2011, the entire contents of which are hereby incorporated by reference.

### FIELD OF THE INVENTION

The invention relates to a method for producing a phosphor, more particularly, to a method for producing a magnesium-alpha-SiAlON-hosted phosphor.

### BACKGROUND OF THE INVENTION

As techniques advance, techniques bring human not only convenient lives but also considerations for over exploitation of the natural resources. Thus, government authorities and environmental protection organizations actively promote strategies on economical energy consumption and environmental protection. Scientists also begin to do related research and development corresponding to such strategies.

A light emitting diode (hereinafter “LED”) is a solid semiconductor, which combines electrons with holes and emits light. Light emitted by an LED is luminescent, and an LED has advantages of compact in size, low heat generated while emitting light, rapid reaction, long lifespan, low electricity consumption, high tolerance for shaking and readily developed design as a thin product. An LED has further advantages of mercury free, no pollutant and recyclability of elements thereof. In recent years when human has the consciousness of environmental protection, energy conservation and carbon dioxide reducing, an LED gradually replaces a conventional incandescent lamp and becomes an indispensable element in our daily lives.

Generally, there are two methods to generate white light by an LED. In the first method, three different LEDs, namely a red light-emitting LED, a green light-emitting LED and a blue light-emitting LED, are combined. Due to the combination of three different lights, white light is generated. In the second method, a mono-light from an LED triggers a phosphor to emit a light complementary to the mono-light of the LED. Due to the mono-light of the LED and the complementary light from the phosphor, white light is generated.

White light generated from the first method has better light performance; however, the cost is high and the lifespan of such a combination is short. Besides, it is also difficult to select proper LEDs to emit lights of different colors with proper wavelengths. Additional drawback of the first method is that the white light is polarized after being used for a period of time, because a red light-emitting LED, a green light-emitting LED and a blue light-emitting LED have different light decay degrees. As a result, in a condition that color rendering is not very strictly demanded, the second method is mainly adopted to generate white light.

Currently, a phosphor is an oxide phosphor, a sulfide phosphor, a nitride phosphor or an oxy-nitride phosphor. Among those, related patents about the oxide phosphor and the sulfide phosphor are abundant in number, and mainly owned by international corporations, e.g. NICHIA CORP. or OSRAM CORP. Furthermore, an oxide phosphor, such as Y₃Al₅O₁₂:Ce³⁺ (YAG:Ce³⁺) and Tb₃Al₅O₁₂:Ce³⁺ (TAG:Ce³⁺), still has drawbacks of insufficient light efficiency, lack of red light triggered and poor color rendering. Likewise, a sulfide phosphor is toxic and poor in chemical reactivity and heat stability. On the other hand, a nitride phosphor and an oxy-nitride phosphor both have advantages such as toxicity free, good chemical reactivity, good heat stability, high energy efficiency, high luminance, and adaptability for compositions and wavelength thereof; thus they are considered as the most potential phosphor.

The method for producing either a nitride phosphor or an oxy-nitride phosphor is implemented under a series of serious conditions. Accordingly, it is said that the current phosphor is difficult to make, and even if the production is finished, the volume is small. Besides, the production is very costly. Because the method is implemented under such serious conditions, correspondingly, the potential risk of endangering the environment for implementing such a method increases. For decreasing the foregoing risk, the apparatus used in the method must be able to withstand harsh conditions, which causes that the prices of the phosphor are too high and consumers have no interest in purchasing related products thereof. As such, the development of the nitride phosphor and the oxy-nitride phosphor has been limited.

There are numerous methods for producing either a nitride phosphor or an oxy-nitride phosphor, such as a solid state method, a gas-pressing sintering method, a gas-reduction and nitridation method and a carbothermal reduction method.

In the solid state method, a reactant is placed in an environment of 1300-1500° C. and 0.1-1 Mpa for several hours for reaction. Because the method is implemented under such high temperature and pressure for hours, the apparatus used therein must have the ability to withstand the temperature and the pressure for safety concern, and consequently, the cost for such apparatus is high. Furthermore, such phosphor produced by the method tends to aggregate or sinter together, leading large particle size. The method further has a polishing process afterwards to minimize its particle size. The polishing process would cause crystal defects in the phosphor to decrease its light efficiency, and the polishing process can not effectively homogenize its particle size.

In the gas-pressing sintering method, a reactant is placed in an environment under 1700-2200° C. and 1-10 Mpa for several hours to accelerate its reactive rate. Like the very first solid state method, the method is under such high temperature and such high pressure for a long time, and the cost for such apparatus used therein is high. Moreover, the method has misgivings for safety when implemented for mass production.

In the gas-reduction and nitridation method, an oxide is employed as a reactant, and then a gas, such as ammonia, methane, propane, carbon monoxide or ammonia/methane, is provided for the oxide, in which the gas is employed as a reactant to provide the oxide with nitrogen. Although the method is not necessarily implemented under high pressure, the gas tends to explode while being reacted and results in danger. Accordingly, the method is not suitable for mass production.

In the carbothermal reduction method, a carbon powder is employed as a reactant, and a nitrogen gas is used, in which the carbon powder is reacted with oxygen to form carbon monoxide and then the nitrogen gas fills the oxygen vacancies of such phosphor produced thereby. Though the method is not implemented under high temperature and high pressure and is safer when compared with any of the previously described methods, the method would unavoidably produce carbide, e.g. silicon carbide. Furthermore, such phosphor produced thereby has remaining un-reacted carbon, which would inevitably decrease the light efficiency thereof. Generally speaking, the method further needs a carbon removing process to increase the purity and the light efficiency of the phosphor.

### SUMMARY OF THE INVENTION

An objective of the invention is to provide a method for producing a phosphor, which is not required to be implemented under high temperature and/or high pressure, and is simple in process and economical in the time required.

For the foregoing or other objective, the method provided in the invention comprises:

providing a blend composed of:
(i) a magnesium source;
(ii) a silicon source;
(iii) an aluminum source;
(iv) an oxygen source;
(v) a solid nitrogen source;
(vi) an ammonium halide; and
(vii) an activator ion source;

coating the blend with an initiator to obtain a tablet;

placing the tablet in a heat insulator;

placing a ceramic powder between the tablet and the heat insulator; and

heating the tablet to obtain a magnesium-alpha-SiAION-hosted phosphor.

### BRIEF DESCRIPTION OF THE DRAWINGS

FIG. 1 is a flow chart to show a method for producing a phosphor.

FIG. 2 is an energy dispersive spectrometric result of the magnesium-alpha-SiAlON-hosted phosphor in Example 1.

### DETAILED DESCRIPTION OF THE INVENTION

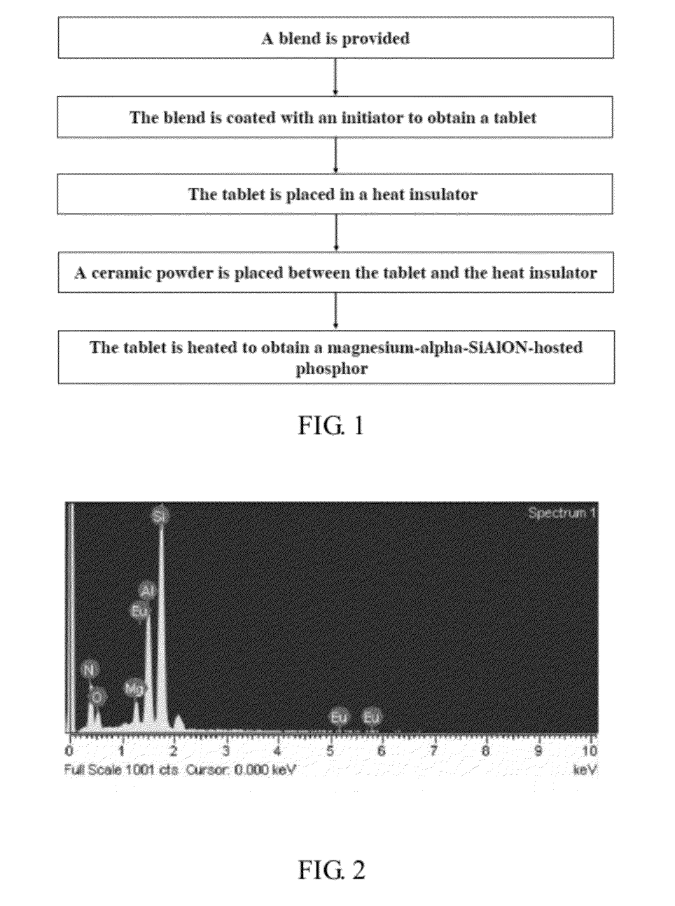

With reference to FIG. 1, a method for producing a phosphor comprises:

providing a blend composed of:
(i) a magnesium source;
(ii) a silicon source;
(iii) an aluminum source;
(iv) an oxygen source;
(v) a solid nitrogen source;
(vi) an ammonium halide; and
(vii) an activator ion source;

coating the blend with an initiator to obtain a tablet;

placing the tablet in a heat insulator;

placing a ceramic powder between the tablet and the heat insulator; and

heating the tablet to obtain a magnesium-alpha-SiAION-hosted phosphor.

In a preferred embodiment of the invention, the phosphor may be a magnesium-alpha-SiAION-hosted phosphor, expressed as a formula of Mgₓ(Si, Al)₁₂(O, N)₁₆:Ln_{y}. In this formula, Mg means magnesium, Al means aluminum, O means oxygen, N means nitrogen, and Ln means an activator ion. Preferably, the activator ion is a cerium ion, a praseodymium ion, a europium ion, a dysprosium ion, an erbium ion, a terbium ion or an ytterbium ion. Furthermore, x indicates the molecular number of magnesium and is greater than zero; y indicates the molecular number of an activator ion and is greater than zero.

The magnesium source is used to provide magnesium for the phosphor. In some embodiments, the magnesium source is magnesium or magnesium oxide.

The silicon source is used to provide silicon for the phosphor. In some embodiments, the silicon source is selected from a group consisting of a silicon element, a silicon-containing compound and a mixture thereof. Preferably, the silicon source is silicon, silicon dioxide, silicon oxide or silicon nitride.

The aluminum source is used to provide aluminum for the phosphor. In some embodiments, the aluminum source is selected from a group consisting of an aluminum metal, an aluminum-containing compound and a mixture thereof. Preferably, the aluminum source is aluminum, aluminum oxide, aluminum nitride or aluminum hydroxide.

The oxygen source is used to provide oxygen for the phosphor. In some embodiments, the oxygen source is selected from a group consisting of a metal oxide, a metal hydroxide and a mixture thereof.

The solid nitrogen source is used to provide nitrogen for the phosphor. In some embodiments, the solid nitrogen source is selected from a group consisting of an alkali metal nitride, an alkaline earth metal nitride, an organic nitride and a mixture thereof. Preferably, the solid nitrogen source is sodium azide, potassium azide or barium azide.

Preferably, the ammonium halide is ammonium fluoride, ammonium chloride, ammonium bromide or ammonium iodide.

The activator ion source is used to provide an activator ion for the phosphor and to activate the phosphor to emit light. In some embodiments, the activator ion source is selected from a group consisting of a transition metal, a transition metal-containing compound, a rare earth metal, a rare earth metal-containing compound and a mixture thereof. Preferably, the rare earth metal is cerium, praseodymium, europium, dysprosium, erbium, terbium or ytterbium; the rare earth metal-containing compound is a compound containing cerium, praseodymium, europium, dysprosium, erbium, terbium or ytterbium. More preferably, the rare earth metal-containing compound is an oxide of cerium, praseodymium, europium, dysprosium, erbium, terbium or ytterbium, or a salt containing cerium, praseodymium, europium, dysprosium, erbium, terbium or ytterbium.

Preferably, the initiator is made of a mixture of titanium/carbon, magnesium/iron (II, III) oxide, aluminum/iron (II, III) oxide or aluminum/iron (III) oxide.

Preferably, the ceramic powder is made of a nitride, an oxide, an oxide hollow sphere, a silicon carbide or a mixture thereof.

In the tablet heating step, the initiator is ignited in an atmosphere to heat the tablet. In some embodiments, the atmosphere is nitrogen, ammonia, inert gas or alkaline gas.

As the steps described above, the solid nitrogen source is dissociated into nitrogen gas and provides desired nitrogen for the invention after the tablet is heated, so that the method of the invention is optionally implemented under nitrogen.

In another aspect, the heat generated after the tablet is heated is absorbed by the ammonium halide so that the tablet can be slowly heated, the dissociation of the solid nitrogen source slows down, and the solid nitrogen source is well used in the invention.

In a further aspect, the heat for producing the phosphor is generated in a short period of time after the tablet is heated so the invention indeed provides a time-economical method.

In a further aspect, the desired heat in the method of the invention is continually provided, the initiator becomes dense after heating the tablet, and the heat insulator and the ceramic powder provide heat preservation for the tablet. As such, the defect in the phosphor decreases and the quality thereof increases.

Other features and advantages of the invention will become apparent in the following detailed description of a preferred embodiment with reference to the accompanying drawings.

### Production of a Magnesium-Alpha-Sialon-Hosted Phosphor

### Example 1

A magnesium-alpha-SiAlON-hosted phosphor is produced by the following steps.

Firstly, a blend composed of magnesium, silicon, aluminum oxide, sodium azide, ammonium chloride and europium oxide with a molar ratio of 0.8:9.2:2:0.4:9.936:4.829:0.03 is prepared. In a tablet machine, the blend is compressed into a precursor tablet with a diameter of 1.7 cm and a height of 1.0 cm.

Afterwards, an initiator composed of magnesium and iron (II, III) oxide with a molar ratio of 4:1 is provided. The initiator is coated outside the precursor tablet, and then compressed in the tablet machine into a tablet with a diameter of 3.0 cm and a height of 2.4 cm.

Thereafter, the tablet is placed in a heat insulator, and then aluminum nitride is positioned between the heat insulator and the tablet to form a reaction unit.

Finally, the reaction unit is put in a sealed reactor with an atmospheric pressure of 5 atm nitrogen, and then the tablet is electrified by tungsten coils and ignited to obtain the magnesium-alpha-SiAlON-hosted phosphor within 1-3 seconds.

### Examples 2-31

A magnesium-alpha-SiAlON-hosted phosphor in each of Examples 2-31 is produced by the same steps described in Example 1, except for the amount and the composition of the tablet used therein. With reference to Table 1, the amount and the composition of the tablet used in each of Examples 2-31 are presented.

TABLE 1

| | Blend (molar ratio) | | | | | | | | | |
|---|---|---|---|---|---|---|---|---|---|---|
| | | | | aluminum | | oxygen | | ammonium | | |
| | magnesium | silicon source | | source | | source | solid nitrogen | halide | | |
| Ex- | source | | silicon | | aluminum | aluminum | source | ammonium | ammonium | ammonium |
| ample | magnesium | Silicon | nitride | aluminum | nitride | oxide | sodium oxide | chloride | bromide | iodide |
| 2 | 0.8 | 7.7 | 0.5 | 2 | — | 0.4 | 9.936 | 4.829 | — | — |
| 3 | 0.8 | 6.2 | 1 | 2 | — | 0.4 | 9.936 | 4.829 | — | — |
| 4 | 0.8 | 9.2 | — | 1.5 | 0.5 | 0.4 | 9.936 | 4.829 | — | — |
| 5 | 0.8 | 9.2 | — | 1 | 1 | 0.4 | 9.936 | 4.829 | — | — |
| 6 | 0.8 | 9.2 | — | 0.5 | 1.5 | 0.4 | 9.936 | 4.829 | — | — |
| 7 | 0.8 | 9.2 | — | — | 2 | 0.4 | 9.936 | 4.829 | — | — |
| 8 | 0.8 | 7.7 | 0.5 | 2 | — | 0.4 | 9.936 | — | 4 | — |
| 9 | 0.8 | 7.7 | 0.5 | 2 | — | 0.4 | 9.936 | — | 6 | — |
| 10 | 0.8 | 7.7 | 0.5 | 2 | — | 0.4 | 9.936 | — | 8 | — |
| 11 | 0.8 | 7.7 | 0.5 | 2 | — | 0.4 | 9.936 | — | 0.8 | 4 |
| 12 | 0.8 | 7.7 | 0.5 | 2 | — | 0.4 | 9.936 | — | 0.8 | 6 |
| 13 | 0.8 | 7.7 | 0.5 | 2 | — | 0.4 | 9.936 | 4.829 | — | — |
| 14 | 0.8 | 7.7 | 0.5 | 2 | — | 0.4 | 9.936 | 4.829 | — | — |
| 15 | 0.8 | 7.7 | 0.5 | 2 | — | 0.4 | 9.936 | 4.829 | — | — |
| 16 | 0.8 | 7.7 | 0.5 | 2 | — | 0.4 | 9.936 | 4.829 | — | — |
| 17 | 0.8 | 7.7 | 0.5 | 2 | — | 0.4 | 9.936 | 4.829 | — | — |
| 18 | 0.8 | 7.7 | 0.5 | 2 | — | 0.4 | 9.936 | 4.829 | — | — |
| 19 | 0.8 | 7.7 | 0.5 | 2 | — | 0.4 | 9.936 | 4.829 | — | — |
| 20 | 0.8 | 7.7 | 0.5 | 2 | — | 0.4 | 9.936 | 4.829 | — | — |
| 21 | 0.8 | 7.7 | 0.5 | 2 | — | 0.4 | 9.936 | 4.829 | — | — |
| 22 | 0.8 | 7.7 | 0.5 | 2 | — | 0.4 | 9.936 | 4.829 | — | — |
| 23 | 0.8 | 7.7 | 0.5 | 2 | — | 0.4 | 9.936 | 4.829 | — | — |
| 24 | 0.8 | 7.7 | 0.5 | 2 | — | 0.4 | 9.936 | 4.829 | — | — |
| 25 | 0.8 | 7.7 | 0.5 | 2 | — | 0.4 | 9.936 | 4.829 | — | — |
| 26 | 0.8 | 7.7 | 0.5 | 2 | — | 0.4 | 9.936 | 4.829 | — | — |
| 27 | 0.8 | 7.7 | 0.5 | 2 | — | 0.4 | 9.936 | 4.829 | — | — |
| 28 | 0.8 | 7.7 | 0.5 | 2 | — | 0.4 | 9.936 | 4.829 | — | — |
| 29 | 0.8 | 7.7 | 0.5 | 2 | — | 0.4 | 9.936 | 4.829 | — | — |
| 30 | 0.8 | 7.7 | 0.5 | 2 | — | 0.4 | 9.936 | 4.829 | — | — |
| 31 | 0.8 | 7.7 | 0.5 | 2 | — | 0.4 | 9.936 | 4.829 | — | — |

| | Blend (molar ratio) | | | | | |
|---|---|---|---|---|---|---|
| | activator ion source | | | Initiator (molar ratio) | | |
| | | europium | cesium | magnesium/iron | titanium/ | aluminum/iron |
| Example | europium | oxide | oxide | (II, III) oxide | carbon | (II, III) oxide |
| 2 | — | 0.03 | — | 4/1 | — | — |
| 3 | — | 0.03 | — | 4/1 | — | — |
| 4 | — | 0.03 | — | 4/1 | — | — |
| 5 | — | 0.03 | — | 4/1 | — | — |
| 6 | — | 0.03 | — | 4/1 | — | — |
| 7 | — | 0.03 | — | 4/1 | — | — |
| 8 | — | 0.03 | — | 4/1 | — | — |
| 9 | — | 0.03 | — | 4/1 | — | — |
| 10 | — | 0.03 | — | 4/1 | — | — |
| 11 | — | 0.03 | — | 4/1 | — | — |
| 12 | — | 0.03 | — | 4/1 | — | — |
| 13 | 0.06 | — | — | 4/1 | — | — |
| 14 | 0.12 | — | — | 4/1 | — | — |
| 15 | 0.24 | — | — | 4/1 | — | — |
| 16 | 0.3 | — | — | 4/1 | — | — |
| 17 | — | 0.01 | — | 4/1 | — | — |
| 18 | — | 0.13 | — | 4/1 | — | — |
| 19 | — | 0.15 | — | 4/1 | — | — |
| 20 | — | 0.17 | — | 4/1 | — | — |
| 21 | — | 0.2 | — | 4/1 | — | — |
| 22 | — | — | 0.06 | 4/1 | — | — |
| 23 | — | — | 0.12 | 4/1 | — | — |
| 24 | — | — | 0.18 | 4/1 | — | — |
| 25 | — | — | 0.24 | 4/1 | — | — |
| 26 | — | — | 0.3 | 4/1 | — | — |
| 27 | — | 0.03 | — | — | 1/0.8 | — |
| 28 | — | 0.03 | — | — | 2/1 | — |
| 29 | — | 0.03 | — | — | 1/2 | — |
| 30 | — | 0.03 | — | — | — | 4/1 |
| 31 | — | 0.03 | — | — | — | 3/1 |

1. “—” indicates no amount of the chemical.

### Analysis of a Magnesium-Alpha-Sialon-Hosted Phosphor

### Examples 1-31

For further understanding the chemical and physical properties of the magnesium-alpha-SiAlON-hosted phosphor in each of Examples 1-31, an energy dispersive spectrometer is used to analyze chemical composition thereof; an X-ray diffraction is used to analyze host thereof; a photoluminescence is used to analyze wavelength of emission light thereof.

With reference to FIG. 2, it shows that the magnesium-alpha-SiAlON-hosted phosphor in Example 1 is composed of nitrogen, oxygen, magnesium, europium, aluminum and silicon.

With reference to Table 2, it shows the host and the wavelength of the emission light of the magnesium-alpha-SiAlON-hosted phosphor in each of Examples 1-31.

TABLE 2

| | | Wavelength of |
|---|---|---|
| | | emission light |
| Example | Host | (nm) |
| 1 | Mg-alpha-SiAlON | 400-650 |
| 2 | Mg-alpha-SiAlON | 400-650 |
| 3 | Mg-alpha-SiAlON | 400-650 |
| 4 | Mg-alpha-SiAlON | 400-650 |
| 5 | Mg-alpha-SiAlON | 400-650 |
| 6 | Mg-alpha-SiAlON | 400-650 |
| 7 | Mg-alpha-SiAlON | 400-650 |
| 8 | Mg-alpha-SiAlON | 400-650 |
| 9 | Mg-alpha-SiAlON | 400-650 |
| 10 | Mg-alpha-SiAlON | 400-650 |
| 11 | Mg-alpha-SiAlON | 400-650 |
| 12 | Mg-alpha-SiAlON | 400-650 |
| 13 | Mg-alpha-SiAlON | 400-650 |
| 14 | Mg-alpha-SiAlON | 400-650 |
| 15 | Mg-alpha-SiAlON | 400-650 |
| 16 | Mg-alpha-SiAlON | 400-650 |
| 17 | Mg-alpha-SiAlON | 400-650 |
| 18 | Mg-alpha-SiAlON | 400-650 |
| 19 | Mg-alpha-SiAlON | 400-650 |
| 20 | Mg-alpha-SiAlON | 400-650 |
| 21 | Mg-alpha-SiAlON | 400-650 |
| 22 | Mg-alpha-SiAlON | 400-650 |
| 23 | Mg-alpha-SiAlON | 400-650 |
| 24 | Mg-alpha-SiAlON | 400-650 |
| 25 | Mg-alpha-SiAlON | 400-650 |
| 26 | Mg-alpha-SiAlON | 400-650 |
| 27 | Mg-alpha-SiAlON | 400-650 |
| 28 | Mg-alpha-SiAlON | 400-650 |
| 29 | Mg-alpha-SiAlON | 400-650 |
| 30 | Mg-alpha-SiAlON | 400-650 |
| 31 | Mg-alpha-SiAlON | 400-650 |

What is claimed is:

1. A method for producing a phosphor, comprising:
providing a blend composed of:
(i) a magnesium source;
(ii) a silicon source;
(iii) an aluminum source;
(iv) an oxygen source;
(v) a solid nitrogen source;
(vi) an ammonium halide; and
(vii) an activator ion source;
coating the blend with an initiator to obtain a tablet;
placing the tablet in a heat insulator;
placing a ceramic powder between the tablet and the heat insulator; and
heating the tablet to obtain a magnesium-alpha-SiAlON-hosted phosphor.

2. The method as claimed in claim 1, wherein the magnesium source is magnesium or magnesium oxide.

3. The method as claimed in claim 1, wherein the silicon source is selected from a group consisting of a silicon element, a silicon-containing compound and a mixture thereof.

4. The method as claimed in claim 1, wherein the silicon source is silicon, silicon dioxide, silicon oxide or silicon nitride.

5. The method as claimed in claim 1, wherein the aluminum source is selected from a group consisting of an aluminum metal, an aluminum-containing compound and a mixture thereof.

6. The method as claimed in claim 1, wherein the aluminum source is aluminum, aluminum oxide, aluminum nitride or aluminum hydroxide.

7. The method as claimed in claim 1, wherein the oxygen source is selected from a group consisting of a metal oxide, a metal hydroxide and a mixture thereof.

8. The method as claimed in claim 1, wherein the solid nitrogen source is selected from a group consisting of an alkali metal nitride, an alkaline earth metal nitride, an organic nitride and a mixture thereof.

9. The method as claimed in claim 1, wherein the solid nitrogen source is sodium azide, potassium azide or barium azide.

10. The method as claimed in claim 1, wherein the ammonium halide is ammonium fluoride, ammonium chloride, ammonium bromide or ammonium iodide.

11. The method as claimed in claim 1, wherein the activator ion source is selected from a group consisting of a transition metal, a transition metal-containing compound, a rare earth metal, a rare earth metal-containing compound and a mixture thereof.

12. The method as claimed in claim 11, wherein the rare earth metal is cerium, praseodymium, europium, dysprosium, erbium, terbium or ytterbium.

13. The method as claimed in claim 11, wherein the rare earth metal-containing compound is a compound containing cerium, praseodymium, europium, dysprosium, erbium, terbium or ytterbium.

14. The method as claimed in claim 11, wherein the rare earth metal-containing compound is an oxide of cerium, praseodymium, europium, dysprosium, erbium, terbium or ytterbium, or a salt containing cerium, praseodymium, europium, dysprosium, erbium, terbium or ytterbium.

15. The method as claimed in claim 1, wherein the initiator is made of a mixture of titanium/carbon, magnesium/iron (II, III) oxide, aluminum/iron (II, III) oxide or aluminum/iron (III) oxide.

16. The method as claimed in claim 1, wherein the ceramic powder is made of a nitride, an oxide, an oxide hollow sphere, a silicon carbide or a mixture thereof.

17. The method as claimed in claim 1, wherein the tablet heating step comprising igniting the initiator in an atmosphere.

18. The method as claimed in claim 17, wherein the atmosphere is nitrogen, ammonia, inert gas or alkaline gas.
